(19) United States
(12) Patent Application Publication
(10) Pub. No.: US 2023/0061781 A1
(43) Pub. Date: Mar. 2, 2023

(54) METHOD OF TREATING A FABRIC WITH DELIVERY PARTICLES

(71) Applicant: The Procter & Gamble Company, Cincinnati, OH (US)

(72) Inventors: Susana Fernandez-Prieto, Benicarlo (ES); Cedric Marc Tahon, Ghent (BE); Johan Smets, Lubbeek (BE); Linsheng Feng, Menasha, WI (US)

(21) Appl. No.: 17/885,616

(22) Filed: Aug. 11, 2022

Related U.S. Application Data
(60) Provisional application No. 63/231,777, filed on Aug. 11, 2021.

(51) Int. Cl. D06M 23/12; D06M 10/00; B65D 81/30

(52) U.S. Cl. CPC D06M 23/12; D06M 10/001; B65D 81/30

(57) ABSTRACT

A method of treating a fabric, where the method includes the steps of contacting a fabric with a treatment composition, where the treatment composition comprises a population of delivery particles having a shell that includes a polymeric material that is the reaction product of a polyisocyanate and chitosan, and exposing the delivery particles that are on the surface of the fabric to ultraviolet (UV) light. A consumer product that includes such treatment compositions in containers that block or absorb ultraviolet light.

### FIELD OF THE INVENTION

The present disclosure relates to a method of treating a fabric with a treatment composition that includes delivery particles having polyisocyanate/chitosan shells. The present disclosure also relates to consumer products that include such treatment compositions in a container that blocks or absorbs ultraviolet light.

### BACKGROUND OF THE INVENTION

Core/shell delivery particles are useful for delivering benefit agents, such as fragrance materials, at various touchpoints. One of those touchpoints can be upon exposure to ultraviolet (UV) light, for example while drying or wearing a fabric in sunshine.

While it is generally desirable for delivery particles to have low levels of leakage, it may be desirable to have some level of benefit agent release, for example through diffusion, prior to the physical rupture of the capsule. That being said, some delivery particles are quite robust, even in UV light, and do not significantly release benefit agents, such as perfume, without rupturing.

To facilitate release in UV light, UV-sensitive moieties can be added to the polymers of the delivery particle shell, but this can have the negative consequence of additional processing steps and/or added cost.

There is a need for methods of treating fabrics with delivery particles that provide a benefit agent release upon exposure to ultraviolet light, such as sunshine. Further, there is a need to protect such delivery particles from ultraviolet light prior to the time of use so that the particles do not prematurely release the benefit agent.

### SUMMARY OF THE INVENTION

The present disclosure relates to a method of treating a fabric, the method comprising the steps of: contacting a fabric with a treatment composition, wherein the treatment composition comprises a population of delivery particles, wherein the contacting step results in one or more of the delivery particles depositing on a surface of the fabric, wherein the delivery particles comprise a core and a shell surrounding the core, wherein the core comprises a benefit agent, wherein the shell wherein the shell comprises a polymeric material that is the reaction product of a polyisocyanate and chitosan; and exposing the delivery particles that are on the surface of the fabric to ultraviolet (UV) light, preferably UV light having a wavelength of from about 200 nm to about 400 nm, more preferably from about 280 nm to about 400 nm.

The present disclosure also relates to a consumer product, wherein the product comprises: a container comprising a wall material, wherein the wall material is capable of blocking or absorbing ultraviolet light, preferably ultraviolet light having a wavelength of from about 200 nm to about 400 nm, more preferably from about 280 nm to about 400 nm; a treatment composition that is contained in the container, wherein the treatment composition comprises a population of delivery particles, wherein the delivery particles comprise a core and a shell surrounding the core, wherein the core comprises a benefit agent, wherein the shell comprises a polymeric material that is the reaction product of a polyisocyanate and chitosan.

### BRIEF DESCRIPTION OF THE DRAWINGS

The figures herein are illustrative in nature and are not intended to be limiting.

FIG. 1 shows a cross-section view of an illustrative consumer product according to the present disclosure.

FIG. 2 shows a consumer product according to the present disclosure in which a sleeve is disposed on the peripheral wall of the container.

### DETAILED DESCRIPTION OF THE INVENTION

The present disclosure relates to a method of treating a fabric with a treatment composition that includes certain delivery particles, and exposing the fabric (with the delivery particles deposited thereon) to ultraviolet light, such as sunshine.

The delivery particles of the present disclosure are core/shell particles, where the shell includes a polymeric material derived from polyisocyanates and chitosan. Without wishing to be bound by theory, it is believed that the shells of the presently described particles, which may be perfume delivery particles, are sufficiently robust to prevent significant leakage during product storage, but are sufficiently sensitive to ultraviolet (UV) light to allow for a gradual release of the encapsulated benefit agent upon exposure to UV light, even during passive activities. For example, when such particles are deposited on fabrics, this can result in a pleasant olfactory experience for the consumer when drying or wearing the fabrics outdoors.

The present disclosure also relates to consumer products that include particular materials intended to protect the delivery particles described herein from premature exposure to ultraviolet (UV) light. For example, treatment compositions that include delivery particles according to the present disclosure may be packaged in containers made from materials that block or absorb ultraviolet light.

The methods, particles, compositions, and products of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Method of Treating a Fabric

The present disclosure relates to methods of treating fabrics. In generally, the method includes the steps of contacting a fabric with a treatment composition and exposing the fabric to ultraviolet (UV) light.

The method includes the step of contacting a fabric with a treatment composition. The treatment composition comprises a population of delivery particles. The contacting step results in one or more of the delivery particles being deposited on a surface of the fabric. The delivery particles comprise a core and a shell surrounding the core, where the core comprises a benefit agent, preferably a fragrance material that comprises one or more perfume raw materials. The shell comprises a polymeric material that is, for example, the reaction product of a polyisocyanate and chitosan. Suitable treatment compositions and delivery particles are described in more detail below.

The contacting step may occur during a manual laundry process, for example in a wash basin as fabrics are treated by hand, or an automatic laundry process, for example in an automatic washing machine. The contacting step may occur during the wash cycle of an automatic washing machine; in such cases, the treatment composition may be a laundry detergent or a laundry additive. The contacting step may preferably occur during the rinse cycle of an automatic washing machine; in such cases, the treatment composition may be a fabric enhancer, preferably a liquid fabric enhancer. The contacting step may even occur during a drying step of a laundry process, for example in an automatic dryer machine; in such cases, the treatment composition may be in the form of a non-woven dryer sheet or a dryer bar. The contacting step may occur as a result of the treatment composition being directly applied to the fabric, for example in a pretreatment operation or in a “refreshing” step (e.g., for a fabric that has been used or worn since the last wash); in such cases, the treatment composition may be in the form of a liquid, a stick, or a spray, preferably a spray. Contacting the target fabrics relatively late in a laundering process, e.g., during a rinse cycle, improves the likelihood or efficiency of deposition onto the fabrics as they are less likely to be washed down the drain.

The contacting step may occur in the presence of water. The treatment composition may be diluted with water to form a treatment liquor. The treatment composition may be diluted from about 100-fold to about 1500-fold, preferably from 300-fold to about 1000-fold.

Liquors that comprise the disclosed compositions may have a pH of from about 3 to about 11.5. When diluted, such compositions are typically employed at concentrations of from about 500 ppm to about 15,000 ppm in solution. When the wash solvent is water, the water temperature typically ranges from about 5° C. to about 90° C. and, the water to fabric ratio may be typically from about 1:1 to about 30:1.

The dilution may occur in the drum of an automatic washing machine. The treatment composition may be placed into a dispensing drawer of an automatic washing machine. The treatment composition may be dispensed from the dispensing drawer to the drum during a treatment process.

The method includes the step of exposing the fabric to UV light. More specifically, the method may be described as exposing at least some of the delivery particles located on the fabric, preferably on a surface of the fabric, to UV light. It is understood that in the methods of the present disclosure, the fabric and or particles need not be exposed to only UV light; other parts of the spectrum are likely to also be present, for example visible light and/or infrared. In other words, the exposing step is intended to be not limited to UV light, rather that UV light should be present (amongst other wavelengths).

Ultraviolet light is a form of electromagnetic radiation that is characterized by wavelengths typically shorter than that of visible light. For example, the wavelength of UV light may be from about 10 nm to about 400 nm. UV light can be further subdivided by wavelength. For example, UV-A radiation has a wavelength of from about 315 nm to about 400 nm, while UV-B radiation has a wavelength of from about 280 nm to about 315 nm. The sun is a common source of UV light, but lighting devices such as ultraviolet lamps can also produce ultraviolet light. The UV light of the present disclosure may preferably from about 200 nm to about 400 nm, preferably from about 280 nm to about 400 nm.

Preferably, the source of UV light is sunlight. Preferably the step of exposing the fabric to UV light occurs outdoors.

The source of UV light may be a lighting device rather than sunlight. Use of such devices may be preferred when the primary usage of the fabric is likely to be indoors. Such lighting devices may be on the interior of an automatic washing machine or an automatic drying machine.

Such lighting devices may be used during or after drying processes, including during or after passive drying processes.

At least a portion of the exposing step may occur during a passive drying process, preferably outdoors, for example during a line-drying processes. Such exposure is believed to lead to a benefit agent release, preferably a perfume release, which can provide a pleasant experience to a user who collects, folds, and/or uses the fabrics.

At least a portion of the exposing step may occur while the fabric is being worn or otherwise used by a person, preferably outdoors. Preferably, the fabric is a garment, such as a shirt. Such exposure is believed to lead to a benefit agent release, preferably a perfume release, which can provide a pleasant experience to a user who wears the fabrics, and/or to those near to the user. In particular, the benefits of the present methods may be particularly appreciated by those who work, commute, or exercise outside.

As alluded to above, the method may further comprise a step of drying the fabric that has the one or more delivery particles on the surface of the fabric. The drying step may comprise a passive drying process, such as on a clothesline or drying rack. The drying step may comprise an automatic drying process, such as in an automatic dryer machine.

### Treatment Composition

The present disclosure relates to treatment compositions. The treatment compositions may be useful in the methods of treating fabrics described herein. The treatment compositions may be useful in the consumer products described herein.

The treatment composition is preferably a fabric care composition, more preferably a fabric conditioning composition, even more preferably a liquid fabric conditioning composition.

The treatment compositions comprise a population of delivery particles. The treatment composition may further comprise one or more adjunct ingredients. Such materials are described in more detail below.

The treatment composition may be in the form of a liquid composition, a granular composition, a hydrocolloid, a single-compartment pouch, a multi-compartment pouch, a dissolvable sheet, a pastille or bead, a fibrous article, a tablet, a stick, a bar, a flake, a foam/mousse, a non-woven sheet, or a mixture thereof.

The treatment composition may be in the form of a liquid. The liquid composition may preferably include from about 50% to about 97%, preferably from about 60% to about 96%, more preferably from about 70% to about 95%, or even from about 80% to about 95%, by weight of the fabric treatment composition, of water. The liquid composition may be a liquid fabric conditioner. The liquid may be packaged in a pourable bottle. The liquid may be packaged in an aerosol can or other spray bottle. Suitable containers are described in more detail below.

The treatment composition may be in the form of a solid. The composition may be in the form of a bead or pastille, which may be pastilled from a liquid melt. The composition may be an extruded product. The treatment composition may be in the form of a powder or granules.

The treatment composition may be in the form of a spray and may be dispensed, for example, from a bottle via a trigger sprayer and/or an aerosol container with a valve.

The treatment composition may have a viscosity of from 1 to 1500 centipoises (1-1500 mPa*s), from 100 to 1000 centipoises (100-1000 mPa*s), or from 200 to 500 centipoises (200-500 mPa*s) at 20 s⁻¹ and 21° C.

The treatment compositions of the present disclosure may be characterized by a pH of from about 2 to about 12, or from about 2 to about 8.5, or from about 2 to about 7, or from about 2 to about 5. The treatment compositions of the present disclosure may have a pH of from about 2 to about 4, preferably a pH of from about 2 to about 3.7, more preferably a pH from about 2 to about 3.5, preferably in the form of an aqueous liquid. It is believed that such pH levels facilitate stability of the quaternary ammonium ester compound, when present. The pH of a composition is determined by dissolving/dispersing the composition in deionized water to form a solution at 10% concentration, at about 20° C.

Additional components and/or features of the compositions are discussed in more detail below.

### Delivery Particles

The treatment compositions of the present disclosure comprise a population of delivery particles. The delivery particles comprise a core and a shell surrounding the core. The core may comprise a benefit agent, and optionally a partitioning modifier. The core can be a liquid or a solid, preferably a liquid, at room temperature.

As described above, the delivery particles of the present disclosure can be used in treatment compositions to effectively encapsulate and delivery a benefit agent, such as fragrance, with relatively low leakage in product. However, once deposited onto a target surface, such as a laundered fabric, it is believed the delivery particles can provide a desirable, gradual release profile when exposed to UV light, such as that provided by sunlight.

The treatment composition may comprise from about 0.05% to about 20%, or from about 0.05% to about 10%, or from about 0.1% to about 5%, or from about 0.2% to about 2%, by weight of the composition, of delivery particles. The composition may comprise a sufficient amount of delivery particles to provide from about 0.05% to about 10%, or from about 0.1% to about 5%, or from about 0.1% to about 2%, by weight of the composition, of the encapsulated benefit agent, which may preferably be perfume raw materials, to the composition. When discussing herein the amount or weight percentage of the delivery particles, it is meant the sum of the wall material and the core material.

The population of delivery particles according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification.

The delivery particles may be characterized by a ratio of core to shell up to 99:1, or even 99.5:1, on the basis of weight.

The delivery particles may be cationic, preferably cationic at a pH of 4.5. The delivery particles may be characterized by a zeta potential of at least 15 millivolts (mV) at a pH of 4.5. The delivery particles can be fashioned to have a zeta potential of at least 15 millivolts (mV) at a pH of 4.5, or even at least 40 mV at a pH of 4.5, or even at least 60 mV at a pH of 4.5. Polyurea capsules prepared with chitosan typically exhibit positive zeta potentials. Such capsules have improved deposition efficiency on fabrics. At higher pH, the particles may be able to be made nonionic or anionic.

The shell of the delivery particles comprises a polymeric material that may be the reaction product of a polyisocyanate and a chitosan. The chitosan may preferably be hydrolyzed chitosan. The shell may comprise a polyurea resin, where the polyurea resin comprises the reaction product of a polyisocyanate and chitosan, preferably hydrolyzed chitosan. The delivery particles of the present disclosure may be considered polyurea delivery particles and include a polyurea-chitosan shell. (As used herein, “shell” and “wall” are used interchangeably with regard to the delivery particles, unless indicated otherwise.) The shell may be derived from isocyanates and chitosan, preferably hydrolyzed chitosan. Without wishing to be bound by theory, it is believed that the present subject matter makes possible tailored surface charge of chitosan urea-based delivery particles by chemical attachment on the surface, especially the external surface of the delivery particle, through the charged domains or charged pendant groups of the resulting polymer.

The population of delivery particles may be made according to a process that comprises the following steps: forming a water phase by hydrolyzing chitosan in an aqueous acidic medium at a pH of 6.5 or less and a temperature of at least 60° C. for at least one hour; forming an oil phase comprising dissolving together at least one benefit agent and at least one polyisocyanate, optionally with an added oil; forming an emulsion by mixing under high shear agitation the water phase and the oil phase into an excess of the water phase, thereby forming droplets of the oil phase and benefit agent dispersed in the water phase, and optionally adjusting the pH of the emulsion to be in a range from pH 2 to pH 6; curing the emulsion by heating to at least 40° C., for a time sufficient to form a shell at an interface of the droplets with the water phase, the shell comprising the reaction product of the polyisocyanate and hydrolyzed chitosan, and the shell surrounding the core comprising the droplets of the oil phase and benefit agent. The curing may occur at a temperature up to about 100° C., more preferably up to about 90° C. The hydrolysis of the chitosan may occur at a temperature up to about 100° C., more preferably up to about 90° C. Such temperatures make it likely that the water remains (e.g., doesn't boil off), so that the desired reactions occur.

The shell of the delivery particles may comprise a polyurea resin, wherein the polyurea resin comprises the reaction product of a polyisocyanate and a chitosan, where the chitosan is first hydrolyzed in an acidic medium at a pH of 6.5 or less, preferably even less than pH 6.5, more preferably at a pH of from 3 to 6, and a temperature of at least 60° C. for at least one hour; where at least 21 wt % of the shell is comprised of moieties derived from the hydrolyzed chitosan; where the shell degrades at least 40% in 14 days (or less) when tested according to test method OECD 301B. The shell formed may be a chitosan-polyurea shell, having a chitosan content of at least 21 wt % based on the weight of the shell.

The delivery particles may be prepared by hydrolyzing chitosan in a first step and creating a water solution of the hydrolyzed chitosan. The hydrolyzed chitosan can be utilized at acidic to neutral pH as a cross-linker to form the shell of a core-shell delivery particle. A pH of at least 2, preferably at least 3, more preferably at least 4, is useful for the water phase to facilitate cross-linking of the hydrolyzed chitosan with the isocyanate monomer. The chitosan in the hydrolyzing step may preferably be depolymerized to a weight average molecular weight of about 95 kilodaltons (kDa) or less. The chitosan of the shell may be characterized by a degree of deacetylation of at least 50%, preferably at least 75%, more preferably at least 85%, or even at least 92%.

It may be preferred to use hydrolyzed chitosan to make the particles of the present disclosure. Without wishing to be bound by theory, it is believed that compared to un-hydrolyzed chitosan, hydrolyzed chitosan has improved solubility in water while also having the ability to act as an emulsifier, making it relatively easier to form delivery particles via interfacial polymerization, which includes an aqueous phase. Particles made from hydrolyzed chitosan may also exhibit favorable biodegradability profiles; for example, degradability tends to increase as the pH of the hydrolysis is decreased below pH 6.5, preferably below 6. Additionally or alternatively, hydrolyzed chitosan may be a more effective cross-linker when reacted with isocyanates/polyurea, perhaps due to its smaller size/lower molecular weight.

Chitosan used in the delivery particle formation process may be first hydrolyzed under acidic conditions (pH 6.5 or less). Optionally the chitosan is hydrolyzed at a pH of from 2 to 6.5, or even from a pH of from 4 to 6. This yields a deacetylated, depolymerized chitosan having water solubility, yet retaining an ability to act as an emulsifier or to replace the need for emulsifier, making additional emulsifiers optional. Small differences in reaction conditions can unexpectedly give rise to encapsulates with significantly different properties. The effect is believed to be more pronounced for reactions where in the chitosan hydrolyzation step, the pH is adjusted to around pH 4, or from pH 2-6, or from pH 3-5, but preferably from pH 3.5-5.

The chitosan may be hydrolyzed at a pH range from pH 2 to pH 6.5 and a temperature of at least 45° C. The chitosan in the hydrolyzing step is deacetylated to at least 75%, or even at least 80%, or at least 85%, or even at least 92%. The chitosan in the hydrolyzing step is depolymerized to a weight average molecular weight of 95 kDa or less.

In the present disclosure, hydrolyzed chitosan is taught used as both crosslinker and emulsifier to prepare polyurea delivery particles. Hydrolyzing has the benefit of deacetylating and depolymerizing chitosan, thereby solubilizing an otherwise difficult-to-handle material. Chitosan may be added into water in a jacketed reactor and at pH from 2 or even from 3 to 6.5, adjusted using acid such as concentrated HCl. The chitosan of this mixture may be hydrolyzed by heating to elevated temperature, such as 85° C. in 60 minutes, and then held at this temperature from 1 minute to 1440 minutes or longer. The water phase is then cooled to 25° C. Optionally, deacetylating may also be further facilitated or enhanced by enzymes to depolymerize or deacetylate the chitosan. An oil phase is prepared by dissolving an isocyanate such as trimers of xylylene Diisocyanate (XDI) or polymers of methylene diphenyl isocyanate (MDI), in oil at 25° C. Diluents, for example isopropyl myristate, may be used to adjust the hydrophilicity of the oil phase. The oil phase is then added into the water phase and milled at high speed to obtain a targeted size. The emulsion is then cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the particles. The slurry is then cooled to room temperature.

Chitosan as a percentage by weight of the shell may be from about 21% up to about 95% of the shell. The ratio of the isocyanate monomer, oligomer, or prepolymer to hydrolyzed chitosan may be up to 1:10 by weight. The ratio of hydrolyzed chitosan in the water phase as compared to the isocyanate in the oil phase may be, based on weight, from 21:79 to 90:10, or even from 1:2 to 10:1, or even from 1:1 to 7:1. The shell may comprise chitosan at a level of 21 wt % or even greater, preferably from about 21 wt % to about 90 wt %, or even from 21 wt % to 85 wt %, or even 21 wt % to 75 wt %, or 21 wt % to 55 wt % of the total shell being chitosan.

The polyisocyanate useful in the invention is to be understood for purposes hereof as isocyanate monomer, isocyanate oligomer, isocyanate prepolymer, or dimer or trimer of an aliphatic or aromatic isocyanate. All such monomers, prepolymers, oligomers, or dimers or trimers of aliphatic or aromatic isocyanates are intended encompassed by the term “polyisocyanate” herein.

The polyisocyanate may be an aliphatic or aromatic monomer, oligomer or prepolymer, usefully comprising two or more isocyanate functional groups. The polyisocyanate may preferably be selected from a group comprising toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, and phenylene diisocyanate.

The polyisocyanate, for example, can be selected from aromatic toluene diisocyanate and its derivatives used in wall formation for encapsulates, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate. The polyisocyanate can be selected from 1,3-diisocyanato-2-methylbenzene, hydrogenated MDI, bis(4-isocyanatocyclohexyl)methane, dicyclohexylmethane-4,4′-diisocyanate, and oligomers and prepolymers thereof. This listing is illustrative and not intended to be limiting of the polyisocyanates useful in the present disclosure.

The polyisocyanates useful in the invention comprise isocyanate monomers, oligomers or prepolymers, or dimers or trimers thereof, having at least two isocyanate groups. Optimal cross-linking can be achieved with polyisocyanates having at least three functional groups.

Polyisocyanates, for purposes of the present disclosure, are understood as encompassing any polyisocyanate having at least two isocyanate groups and comprising an aliphatic or aromatic moiety in the monomer, oligomer, or prepolymer. If aromatic, the aromatic moiety can comprise a phenyl, a toluyl, a xylyl, a naphthyl or a diphenyl moiety, more preferably a toluyl or a xylyl moiety. Aromatic polyisocyanates, for purposes herein, can include diisocyanate derivatives such as biurets and polyisocyanurates. The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or trimethylol propane-adduct of xylylene diisocyanate (commercially available from Mitsui Chemicals under the tradename Takenate® D-110N), naphthalene-1,5-diisocyanate, and phenylene diisocyanate.

There is a preference for aromatic polyisocyanate; however, aliphatic polyisocyanates and blends thereof may be useful. Aliphatic polyisocyanate is understood as a polyisocyanate which does not comprise any aromatic moiety. Aliphatic polyisocyanates include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100).

The particle shell may also be reinforced using additional co-crosslinkers such as multifunctional amines and/or polyamines such as diethylene triamine (DETA), polyethylene imine, polyvinyl amine, or mixtures thereof.

The shell may be present at a level of from about 1 to 15 percent by weight of the delivery particle. The shell may be present at a level of least 1%, preferably at least 3%, more preferably at least 5% by weight of the delivery particle. The shell may be present at a level of up to about 15% by weight of the delivery particle.

The shell may degrade at least 50% after 20 days (or less) when tested according to test method OECD 301B. The shell may degrade at least 60% of its mass after 60 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The delivery particles of the present disclosure include a core. The core comprises a benefit agent. The core optionally comprises a partitioning modifier.

The core of a particle is surrounded by the shell. When the shell is ruptured, the benefit agent in the core is released. Suitable benefit agents located in the core may include benefit agents that provide benefits to a surface, such as a fabric or hair.

The core may comprise from about 5% to about 100%, by weight of the core, of a benefit agent, which may preferably comprise a fragrance. The core may comprise from about 45% to about 95%, preferably from about 50% to about 80%, more preferably from about 50% to about 70%, by weight of the core, of the benefit agent, which may preferably comprise a fragrance.

The benefit agent may comprise an aldehyde-comprising benefit agent, a ketone-comprising benefit agent, or a combination thereof. Such benefit agents, such as aldehyde- or ketone-containing perfume raw materials, are known to provide preferred benefits, such as freshness benefits. The benefit agent may comprise at least about 20%, preferably at least about 25%, more preferably at least about 40%, even more preferably at least about 50%, by weight of the benefit agent, of aldehyde-containing benefit agents, ketone-containing benefit agents, or combinations thereof.

The benefit agent may be a hydrophobic benefit agent. Such agents are compatible with the oil phases that are common in making the delivery particles of the present disclosure.

The benefit agent may be selected from the group consisting of fragrance, silicone oils, waxes, hydrocarbons, higher fatty acids, essential oils, lubricants, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, glycerin, synthetic or natural actives, antibacterial actives, antiperspirant actives, cationic polymers, dyes, and mixtures thereof.

The encapsulated benefit agent may preferably comprise a fragrance, which may include one or more perfume raw materials. Fragrance is particularly suitable for encapsulation in the presently described delivery particles, as the fragrance-containing particles can provide freshness benefits across multiple touchpoints.

The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partitioning coefficient (P), which may be described in terms of log P, determined according to the test method below. Based on these characteristics, the PRMs may be categorized as Quadrant I, Quadrant II, Quadrant III, or Quadrant IV perfumes, as described in more detail below.

The fragrance may comprise perfume raw materials that have a log P of from about 2.5 to about 4. It is understood that other perfume raw materials may also be present in the fragrance.

The perfume raw materials may comprise a perfume raw material selected from the group consisting of perfume raw materials having a boiling point (B.P.) lower than about 250° C. and a log P lower than about 3, perfume raw materials having a B.P. of greater than about 250° C. and a log P of greater than about 3, perfume raw materials having a B.P. of greater than about 250° C. and a log P lower than about 3, perfume raw materials having a B.P. lower than about 250° C. and a log P greater than about 3 and mixtures thereof. Perfume raw materials having a boiling point B.P. lower than about 250° C. and a log P lower than about 3 are known as Quadrant I perfume raw materials. Quadrant 1 perfume raw materials are preferably limited to less than 30% of the perfume composition. Perfume raw materials having a B.P. of greater than about 250° C. and a log P of greater than about 3 are known as Quadrant IV perfume raw materials, perfume raw materials having a B.P. of greater than about 250° C. and a log P lower than about 3 are known as Quadrant II perfume raw materials, perfume raw materials having a B.P. lower than about 250° C. and a log P greater than about 3 are known as a Quadrant III perfume raw materials. Suitable Quadrant I, II, III and IV perfume raw materials are disclosed in U.S. Pat. No. 6,869,923 B1.

The consumer product composition according to any preceding claim, wherein the benefit agent comprises fragrance, preferably wherein the fragrance comprises at least about 20%, preferably at least about 25%, more preferably at least about 40%, even more preferably at least about 50%, by weight of the fragrance, of aldehyde-containing perfume raw materials, ketone-containing perfume raw materials, or combinations thereof.

Preferred aldehyde-containing perfume raw materials may include: methyl nonyl acetaldehyde: benzaldehyde; floralozone; isocyclocitral; triplal (ligustral); precyclemone B; lilial; decyl aldehyde; undecylenic aldehyde; cyclamen homoaldehyde; cyclamen aldehyde; dupical; oncidal; adoxal; melonal; calypsone; anisic aldehyde; heliotropin; cuminic aldehyde; scentenal; 3,6-dimethylcyclohex-3-ene-1-carbaldehyde; satinaldehyde; canthoxal; vanillin; ethyl vanillin; cinnamic aldehyde; cis-4-decenal; trans-4-decenal; cis-7-decenal; undecylenic aldehyde; trans-2-hexenal; trans-2-octenal; 2-undecenal; 2,4-dodecadeienal; cis-4-heptenal; Florydral; butyl cinnamaldehyde; limonelal; amyl cinnamaldehyde; hexyl cinnamaldehyde; citronellal; citral; cis-3-hexen-1-al; or mixtures thereof.

Preferred ketone-containing raw materials may include: nerolione; 4-(4-methoxyphenyl)butan-2-one; 1-naphthalen-2-ylethanone; nectaryl; trimofix O; fleuramone; delta-damascone; beta-damascone; alpha-damascone; methyl ionone; 2-hexylcyclopent-2-en-1-one; galbascone; or mixtures thereof.

The core of the delivery particles of the present disclosure may comprise a partitioning modifier, which may facilitate more robust shell formation. The partitioning modifier may be combined with the core's perfume oil material prior to incorporation of the wall-forming monomers. The partitioning modifier may be present in the core at a level of from about 5% to about 55%, preferably from about 10% to about 50%, more preferably from about 25% to about 50%, by weight of the core.

The partitioning modifier may comprise a material selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof. The partitioning modifier may preferably comprise or even consist of isopropyl myristate. The modified vegetable oil may be esterified and/or brominated. The modified vegetable oil may preferably comprise castor oil and/or soy bean oil. US Patent Application Publication 20110268802, incorporated herein by reference, describes other partitioning modifiers that may be useful in the presently described delivery particles.

Where the benefit agent is not itself sufficient to serve as the oil phase or solvent, particularly for the wall forming materials, the oil phase can comprise a suitable carrier and/or solvent. In this sense, the oil is optional, as the benefit agent itself can at times be the oil. These carriers or solvents are generally an oil, preferably have a boiling point greater than about 80° C. and low volatility and are non-flammable. Though not limited thereto, they preferably comprise one or more esters, preferably with chain lengths of up to 18 carbon atoms or even up to 42 carbon atoms and/or triglycerides such as the esters of C6 to C12 fatty acids and glycerol. Exemplary carriers and solvents include, but are not limited to: ethyldiphenylmethane; isopropyl diphenylethane; butyl biphenyl ethane; benzylxylene; alkyl biphenyls such as propylbiphenyl and butylbiphenyl; dialkyl phthalates e.g. dibutyl phthalate, dioctylphthalate, dinonyl phthalate and ditridecylphthalate; 2,2,4-trimethyl-1,3-pentanediol diisobutyrate; alkyl benzenes such as dodecyl benzene; alkyl or aralkyl benzoates such as benzyl benzoate; diaryl ethers; di(aralkyl)ethers and aryl aralkyl ethers; ethers such as diphenyl ether, dibenzyl ether and phenyl benzyl ether; liquid higher alkyl ketones (having at least 9 carbon atoms); alkyl or aralkyl benzoates, e.g., benzyl benzoate; alkylated naphthalenes such as dipropylnaphthalene; partially hydrogenated terphenyls; high-boiling straight or branched chain hydrocarbons; alkaryl hydrocarbons such as toluene; vegetable and other crop oils such as canola oil, soybean oil, corn oil, sunflower oil, cottonseed oil, lemon oil, olive oil and pine oil; methyl esters of fatty acids derived from transesterification of vegetable and other crop oils, methyl ester of oleic acid, esters of vegetable oil, e.g. soybean methyl ester, straight chain paraffinic aliphatic hydrocarbons, and mixtures of the foregoing.

Optionally, the water phase may include an emulsifier. Non-limiting examples of emulsifiers include water-soluble salts of alkyl sulfates, alkyl ether sulfates, alkyl isothionates, alkyl carboxylates, alkyl sulfosuccinates, alkyl succinamates, alkyl sulfate salts such as sodium dodecyl sulfate, alkyl sarcosinates, alkyl derivatives of protein hydrolyzates, acyl aspartates, alkyl or alkyl ether or alkylaryl ether phosphate esters, sodium dodecyl sulphate, phospholipids or lecithin, or soaps, sodium, potassium or ammonium stearate, oleate or palmitate, alkylarylsulfonic acid salts such as sodium dodecylbenzenesulfonate, sodium dialkylsulfosuccinates, dioctyl sulfosuccinate, sodium dilaurylsulfosuccinate, poly(styrene sulfonate) sodium salt, isobutylene-maleic anhydride copolymer, gum arabic, sodium alginate, carboxymethylcellulose, cellulose sulfate and pectin, poly(styrene sulfonate), isobutylene-maleic anhydride copolymer, carrageenan, sodium alginate, pectic acid, tragacanth gum, almond gum and agar; semi-synthetic polymers such as carboxymethyl cellulose, sulfated cellulose, sulfated methylcellulose, carboxymethyl starch, phosphated starch, lignin sulfonic acid; and synthetic polymers such as maleic anhydride copolymers (including hydrolyzates thereof), polyacrylic acid, polymethacrylic acid, acrylic acid butyl acrylate copolymer or crotonic acid homopolymers and copolymers, vinyl benzenesulfonic acid or 2-acrylamido-2-methylpropanesulfonic acid homopolymers and copolymers, and partial amide or partial ester of such polymers and copolymers, carboxy modified polyvinyl alcohol, sulfonic acid-modified polyvinyl alcohol and phosphoric acid-modified polyvinyl alcohol, phosphated or sulfated tristyrylphenol ethoxylates, palmitamidopropyltrimonium chloride (Varisoft PATC™, available from Degussa Evonik, Essen, Germany), distearyl dimonium chloride, cetyltrimethylammonium chloride, quaternary ammonium compounds, fatty amines, aliphatic ammonium halides, alkyldimethylbenzylammonium halides, alkyldimethylethylammonium halides, polyethyleneimine, poly(2-dimethylamino)ethyl methacrylate) methyl chloride quaternary salt, poly(1-vinylpyrrolidone-co-2-dimethylaminoethyl methacrylate), poly(acrylamide-co-di allyldimethylammonium chloride), poly(allylamine), poly [bis(2-chloroethyl) ether-alt-1,3-bis[3-(dimethylamino)propyl]urea] quaternized, and poly(dimethylamine-co-epichlorohydrin-co-ethylenediamine), condensation products of aliphatic amines with alkylene oxide, quaternary ammonium compounds with a long-chain aliphatic radical, e.g. distearyldiammonium chloride, and fatty amines, alkyldimethylbenzylammonium halides, alkyldimethylethylammonium halides, polyalkylene glycol ether, condensation products of alkyl phenols, aliphatic alcohols, or fatty acids with alkylene oxide, ethoxylated alkyl phenols, ethoxylated aryl phenols, ethoxylated polyaryl phenols, carboxylic esters solubilized with a polyol, polyvinyl alcohol, polyvinyl acetate, or copolymers of polyvinyl alcohol polyvinyl acetate, polyacrylamide, poly(N-isopropylacrylamide), poly(2-hydroxypropyl methacrylate), poly(-ethyl-2-oxazoline), poly(2-isopropenyl-2-oxazoline-co-methyl methacrylate), poly(methyl vinyl ether), and polyvinyl alcohol-co-ethylene), and cocoamidopropyl betaine. Emulsifier, if employed, is typically from about 0.1 to 40% by weight, preferably 0.2 to about 15% by weight, more typically 0.5 to 10% be weight, based on total weight of the formulation

Delivery particles may also have varying ratios of the partitioning modifier to the benefit agent so as to make different populations of delivery particles that may have different bloom patterns. Such populations may also incorporate different perfume oils so as to make populations of delivery particles that display different bloom patterns and different scent experiences. US 2011-0268802 discloses other non-limiting examples of delivery particles and partitioning modifiers and is hereby incorporated by reference.

In the formation of the chitosan delivery particles, the aqueous solution may contain a residual quantity of the hydrolyzed chitosan. This provides the option of dewatering the delivery particles such as through decanting, filtration, centrifuging or other separation technique. Alternatively, the aqueous slurry of chitosan polyurea delivery particles can be spray dried forming chitosan polyurea delivery particles further coated with a layer of the residual hydrolyzed chitosan from the water phase.

The formed slurry of delivery particles can be further dispersed in additional water or with low concentration of residual overcoating hydrolyzed chitosan yielding chitosan polyurea delivery particles that can fracture upon drying, providing an additional release mechanism useful in some applications such as fragrance delivery or with agricultural actives for targeted delivery.

The population of delivery particles may comprise of one or more distinct populations. The composition may have at least two different populations of delivery particles that vary in the exact make-up of the perfume oil and in the median particle size and/or partitioning modifier to perfume oil (PM:PO) weight ratio. In some examples, the composition includes more than two distinct populations that vary in the exact make up the perfume oil and in their fracture strengths. In some further examples, the populations of delivery particles can vary with respect to the weight ratio of the partitioning modifier to the perfume oil(s). In some examples, the composition can include a first population of delivery particles having a first ratio that is a weight ratio of from 2:3 to 3:2 of the partitioning modifier to a first perfume oil and a second population of delivery particles having a second ratio that is a weight ratio of less than 2:3 but greater than 0 of the partitioning modifier to a second perfume oil.

Each distinct population of delivery particles may be preparable in a distinct slurry. For example, the first population of delivery particles can be contained in a first slurry and the second population of delivery particles contained in a second slurry. It is to be appreciated that the number of distinct slurries for combination is without limit and a choice of the formulator such that 3, 10, or 15 distinct slurries may be combined. The first and second populations of delivery particles may vary in the exact make up the perfume oil and in the median particle size and/or PM:PO weight ratio.

The compositions of the present disclosure can be prepared by combining the first and second slurries with at least one adjunct ingredient and optionally packaged in a container. The first and second populations of delivery particles can be prepared in distinct slurries and then spray dried to form a particulate. The distinct slurries may be combined before spray drying, or spray dried individually and then combined together when in particulate powder form. Once in powder form, the first and second populations of delivery particles may be combined with an adjunct ingredient to form the composition useful as a feedstock for manufacture of consumer, industrial, medical or other goods. At least one population of delivery particles is spray dried and combined with a slurry of a second population of delivery particles. At least one population of delivery particles may be dried, prepared by spray drying, fluid bed drying, tray drying, or other such drying processes that are available.

The composition can be prepared by combining the first and second slurries with at least one adjunct ingredient and optionally packaged in a container. The first and second populations of delivery particles can be prepared in distinct slurries and then spray dried to form a particulate. The distinct slurries may be combined before spray drying, or spray dried individually and then combined together when in particulate powder form. Once in powder form, the first and second populations of delivery particles may be combined with an adjunct ingredient to form the composition useful as a feedstock for manufacture of consumer, industrial, medical or other goods. At least one population of delivery particles may be is spray dried and combined with a slurry of a second population of delivery particles. At least one population of delivery particles may be dried, prepared by spray drying, fluid bed drying, tray drying, or other such drying processes that are available.

The slurry or dry particulates can include one or more adjunct materials such as processing aids selected from the group consisting of a carrier, an aggregate inhibiting material, a deposition aid, a particle suspending polymer, and mixtures thereof. Non-limiting examples of aggregate inhibiting materials include salts that can have a charge-shielding effect around the particle, such as magnesium chloride, calcium chloride, magnesium bromide, magnesium sulfate, and mixtures thereof. Non-limiting examples of particle suspending polymers include polymers such as xanthan gum, carrageenan gum, guar gum, shellac, alginates, chitosan; cellulosic materials such as carboxymethyl cellulose, hydroxypropyl methyl cellulose, cationically charged cellulosic materials; polyacrylic acid; polyvinyl alcohol; hydrogenated castor oil; ethylene glycol distearate; and mixtures thereof.

The slurry can include one or more processing aids, which may be include water, aggregate inhibiting materials such as divalent salts, or particle suspending polymers such as xanthan gum, guar gum, and/or carboxy methyl cellulose.

The slurry can include one or more carriers selected from the group consisting of polar solvents, including but not limited to, water, ethylene glycol, propylene glycol, polyethylene glycol, glycerol; nonpolar solvents, including but not limited to, mineral oil, perfume raw materials, silicone oils, hydrocarbon paraffin oils, and mixtures thereof.

The slurry may include a deposition aid that may comprise a polymer selected from the group comprising: polysaccharides, in one aspect, cationically modified starch and/or cationically modified guar; polysiloxanes; poly diallyl dimethyl ammonium halides; copolymers of poly diallyl dimethyl ammonium chloride and polyvinyl pyrrolidone; a composition comprising polyethylene glycol and polyvinyl pyrrolidone; acrylamides; imidazoles; imidazolinium halides; polyvinyl amine; copolymers of poly vinyl amine and N-vinyl formamide; polyvinyl formamide, polyvinyl alcohol; polyvinyl alcohol crosslinked with boric acid; polyacrylic acid; polyglycerol ether silicone cross-polymers; polyacrylic acids, polyacrylates, copolymers of polyvinylamine and polvyinylalcohol oligomers of amines, in one aspect a diethylenetriamine, ethylene diamine, bis(3-aminopropyl)piperazine, N,N-Bis-(3-aminopropyl)methylamine, tris(2-aminoethyl)amine and mixtures thereof; polyethyleneimine, a derivatized polyethyleneimine, in one aspect an ethoxylated polyethyleneimine; a polymeric compound comprising, at least two moieties selected from the moieties consisting of a carboxylic acid moiety, an amine moiety, a hydroxyl moiety, and a nitrile moiety on a backbone of polybutadiene, polyisoprene, polybutadiene/styrene, polybutadiene/acrylonitrile, carboxyl-terminated polybutadiene/acrylonitrile or combinations thereof; pre-formed coacervates of anionic surfactants combined with cationic polymers; polyamines and mixtures thereof.

At least one population of delivery particles may be contained in an agglomerate and then combined with a distinct population of delivery particles and at least one adjunct material. Said agglomerate may comprise materials selected from the group consisting of silicas, citric acid, sodium carbonate, sodium sulfate, sodium chloride, and binders such as sodium silicates, modified celluloses, polyethylene glycols, polyacrylates, polyacrylic acids, zeolites and mixtures thereof.

Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

The population of microcapsules may be part of an aqueous slurry that includes (residual) hydrolyzed chitosan in the slurry. The aqueous slurry may be spray dried, forming microcapsules overcoated with a layer of residual hydrolyzed chitosan deposited onto the microcapsules from the slurry.

The process may include drying the delivery particles, and where the delivery particles fracture upon drying, thereby releasing the core. Dry-pop type capsules, which fracture on drying, are formed through controlling reaction conditions such as controlling cure time and controlling temperature to yield capsules with thinner walls. Higher cure temperatures, along with longer cure times, can promote higher crosslinking density and enhanced brittleness. A thinner wall, such as from 0.1 nanometer to about 300 nanometers, tends to lend itself to becoming brittle on drying. Even in the dry-pop embodiment, the capsules of the present disclosure can exhibit lower leakage and better retention of the core in the capsule slurry pre-drying.

### Adjunct Materials

The treatment compositions of the present disclosure may comprise one or more adjunct materials in addition to the delivery particles. The adjunct material may provide a benefit in the intended end-use of a composition, or it may be a processing and/or stability aid.

Suitable adjunct materials may include: surfactants, conditioning actives, deposition aids, rheology modifiers or structurants, bleach systems, stabilizers, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure elasticizing agents, carriers, hydrotropes, processing aids, anti-agglomeration agents, coatings, formaldehyde scavengers, and/or pigments. Preferably, the adjunct materials comprise additional fabric conditioning agents, dyes, pH control agents, solvents, rheology modifiers, structurants, cationic polymers, surfactants, perfume, additional perfume delivery systems, chelants, antioxidants, preservatives, or mixtures thereof.

Depending on the intended form, formulation, and/or end-use, compositions of the present disclosure might not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids, structurants, anti-agglomeration agents, coatings, formaldehyde scavengers, and/or pigments.

The precise nature of these additional components, and levels of incorporation thereof, will depend on the physical form of the composition and the nature of the operation for which it is to be used. However, when one or more adjuncts are present, such one or more adjuncts may be present as detailed below. The following is a non-limiting list of suitable additional adjuncts.

A. Surfactants

The compositions of the present disclosure may comprise surfactant. Surfactants may be useful for providing, for example, cleaning benefits. The compositions may comprise a surfactant system, which may contain one or more surfactants.

The compositions of the present disclosure may include from about 0.1% to about 70%, or from about 2% to about 60%, or from about 5% to about 50%, by weight of the composition, of a surfactant system. Liquid compositions may include from about 5% to about 40%, by weight of the composition, of a surfactant system. Compact formulations, including compact liquids, gels, and/or compositions suitable for a unit dose form, may include from about 25% to about 70%, or from about 30% to about 50%, by weight of the composition, of a surfactant system.

The surfactant system may include anionic surfactant, nonionic surfactant, zwitterionic surfactant, cationic surfactant, amphoteric surfactant, or combinations thereof. The surfactant system may include linear alkyl benzene sulfonate, alkyl ethoxylated sulfate, alkyl sulfate, nonionic surfactant such as ethoxylated alcohol, amine oxide, or mixtures thereof. The surfactants may be, at least in part, derived from natural sources, such as natural feedstock alcohols.

Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES), alkyl sulfates (AS), or mixtures thereof. Other suitable anionic surfactants include branched modified alkyl benzene sulfonates (MLAS), methyl ester sulfonates (MES), sodium lauryl sulfate (SLS), sodium lauryl ether sulfate (SLES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine). Due to the presence of cationic ester quat material, it may be desirable to limit the amount of anionic surfactant so as to avoid undesirable interactions of the materials; for example, the compositions may comprise less than 5%, preferably less than 3%, more preferably less than 1%, even more preferably less than 0.1%, by weight of the composition, of anionic surfactant.

The surfactant system may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branhed alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof. The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C12-C14 EO7 nonionic surfactant.

Suitable zwitterionic surfactants may include any conventional zwitterionic surfactant, such as betaines, including alkyl dimethyl betaine and cocodimethyl amidopropyl betaine, C₈ to C₁₈ (for example from C₁₂ to C₁₈) amine oxides (e.g., C₁₂₋₁₄ dimethyl amine oxide), and/or sulfo and hydroxy betaines, such as N-alkyl-N,N-dimethylammino-1-propane sulfonate where the alkyl group can be C₈ to C₁₈, or from C₁₀ to C₁₄. The zwitterionic surfactant may include amine oxide.

Depending on the formulation and/or the intended end-use, the composition may be substantially free of certain surfactants. For example, liquid fabric enhancer compositions, such as fabric softeners, may be substantially free of anionic surfactant, as such surfactants may negatively interact with cationic ingredients.

B. Conditioning Active

The compositions of the present disclosure may include a conditioning active.

Compositions that contain conditioning actives may provide softness, anti-wrinkle, anti-static, conditioning, anti-stretch, color, and/or appearance benefits.

Conditioning actives may be present at a level of from about 1% to about 99%, by weight of the composition. The composition may include from about 1%, or from about 2%, or from about 3%, to about 99%, or to about 75%, or to about 50%, or to about 40%, or to about 35%, or to about 30%, or to about 25%, or to about 20%, or to about 15%, or to about 10%, by weight of the composition, of conditioning active. The composition may include from about 5% to about 30%, by weight of the composition, of conditioning active.

Conditioning actives suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. Preferably the treatment composition is a fabric care composition where the one or more adjunct ingredients comprises quaternary ammonium ester material; such materials are particularly useful in fabric enhancing/conditioning/softening compositions.

The composition may include a quaternary ammonium ester compound, a silicone, or combinations thereof, preferably a combination. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

The composition may contain mixtures of different types of conditioning actives. The compositions of the present disclosure may contain a certain conditioning active but be substantially free of others. For example, the composition may be free of quaternary ammonium ester compounds, silicones, or both. The composition may comprise quaternary ammonium ester compounds but be substantially free of silicone. The composition may comprise silicone but be substantially free of quaternary ammonium ester compounds.

C. Deposition Aid

The compositions of the present disclosure may comprise a deposition aid. As described above, due to the synergistic benefits that flow from the ester quat material and the delivery particles of the present disclosure, relatively less (or even none) of a deposition aid may be require to provide comparable or even improved performance; alternatively, a deposition aid may be used in compositions of the present disclosure to boost performance even more.

Deposition aids can facilitate deposition of delivery particles, conditioning actives, perfumes, or combinations thereof, improving the performance benefits of the compositions and/or allowing for more efficient formulation of such benefit agents. The composition may comprise, by weight of the composition, from 0.0001% to 3%, preferably from 0.0005% to 2%, more preferably from 0.001% to 1%, or from about 0.01% to about 0.5%, or from about 0.05% to about 0.3%, of a deposition aid. The deposition aid may be a cationic or amphoteric polymer, preferably a cationic polymer.

Cationic polymers in general and their methods of manufacture are known in the literature. Suitable cationic polymers may include quaternary ammonium polymers known the “Polyquaternium” polymers, as designated by the International Nomenclature for Cosmetic Ingredients, such as Polyquaternium-6 (poly(diallyldimethylammonium chloride), Polyquaternium-7 (copolymer of acrylamide and diallyldimethylammonium chloride), Polyquaternium-10 (quaternized hydroxyethyl cellulose), Polyquaternium-22 (copolymer of acrylic acid and diallyldimethylammonium chloride), and the like.

The deposition aid may be selected from the group consisting of polyvinylformamide, partially hydroxylated polyvinylformamide, polyvinylamine, polyethylene imine, ethoxylated polyethylene imine, polyvinylalcohol, polyacrylates, and combinations thereof. The cationic polymer may comprise a cationic acrylate.

Deposition aids can be added concomitantly with delivery particles (at the same time with, e.g., encapsulated benefit agents) or directly/independently in the consumer product composition. The weight-average molecular weight of the polymer may be from 500 to 5000000 or from 1000 to 2000000 or from 2500 to 1500000 Dalton, as determined by size exclusion chromatography relative to polyethyleneoxide standards using Refractive Index (RI) detection. The weight-average molecular weight of the cationic polymer may be from 5000 to 37500 Dalton.

D. Rheology Modifier/Structurant

The compositions of the present disclosure may contain a rheology modifier and/or a structurant. Rheology modifiers may be used to “thicken” or “thin” liquid compositions to a desired viscosity. Structurants may be used to facilitate phase stability and/or to suspend or inhibit aggregation of particles in liquid composition, such as the delivery particles as described herein.

Suitable rheology modifiers and/or structurants may include non-polymeric crystalline hydroxyl functional structurants (including those based on hydrogenated castor oil), polymeric structuring agents, cellulosic fibers (for example, microfibrillated cellulose, which may be derived from a bacterial, fungal, or plant origin, including from wood), di-amido gellants, or combinations thereof.

Polymeric structuring agents may be naturally derived or synthetic in origin. Naturally derived polymeric structurants may comprise hydroxyethyl cellulose, hydrophobically modified hydroxyethyl cellulose, carboxymethyl cellulose, polysaccharide derivatives and mixtures thereof. Polysaccharide derivatives may comprise pectine, alginate, arabinogalactan (gum Arabic), carrageenan, gellan gum, xanthan gum, guar gum and mixtures thereof. Synthetic polymeric structurants may comprise polycarboxylates, polyacrylates, hydrophobically modified ethoxylated urethanes, hydrophobically modified non-ionic polyols and mixtures thereof. Polycarboxylate polymers may comprise a polyacrylate, polymethacrylate or mixtures thereof. Polyacrylates may comprise a copolymer of unsaturated mono- or di-carbonic acid and C₁-C₃₀ alkyl ester of the (meth)acrylic acid. Such copolymers are available from Noveon inc under the tradename Carbopol Aqua 30. Another suitable structurant is sold under the tradename Rheovis CDE, available from BASF.

E. Other Adjuncts

The treatment compositions of the present disclosure may contain other adjuncts that are suitable for inclusion in the product and/or for final usage. For example, the treatment compositions may comprise neat perfume, perfume delivery technologies (such as pro-perfumes and/or encapsulates having non-polyisocyanate/chitosan wall materials), cationic surfactants, cationic polymers, solvents, suds supressors, or combinations thereof.

The treatment compositions may comprise dyes, pigments, opacifying agents, or other materials that absorb, block, reflect, or scatter ultraviolet light. Suitable opacifying agents may include styrene/acrylate copolymers or derivatives thereof, titanium dioxide, tin dioxide, any suitable forms of modified TiO₂ (such as carbon-modified TiO₂ or metallic-doped TiO₂), stannic oxide, bismuth oxychloride, bismuth oxychloride coated TiO₂/Mica, silica coated TiO₂, metal-oxide-coated TiO₂, or mixtures thereof. Such adjuncts can further help to protect the delivery particles of the present disclosure from prematurely releasing the encapsulated benefit agent. Such adjuncts may be particularly useful when the treatment composition is contained in a transparent or translucent container.

### Consumer Product

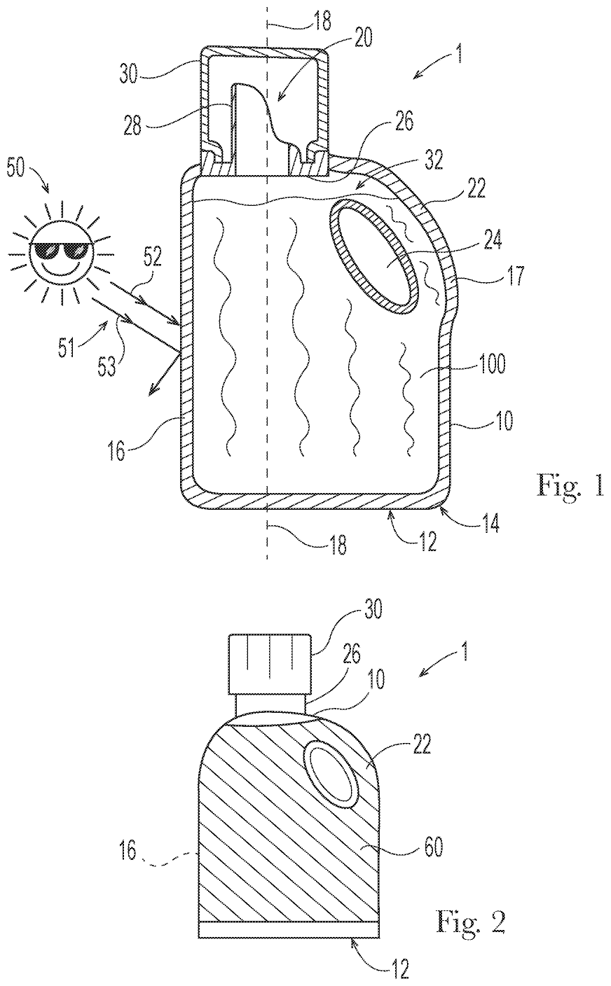

The present disclosure also relates to consumer products. Such consumer products comprise a container and a treatment composition that is contained or disposed in the container. The wall of the container is selected to be capable of blocking or absorbing UV light, so as to protect the delivery particles contained therein. FIG. 1 shows a cross-section view of an illustrative consumer product 1 according to the present disclosure.

The consumer product 1 comprises a container 10. The container 10 comprises a closed end 12 having a closed end periphery 14. A peripheral wall 16 extends upwardly about a longitudinal axis 18 to an open end 20. The container 10 may comprise a handle 22, which may be a through handle adjacent a through hole 24. As shown in FIG. 1, the container 10 may be in the form of a bottle.

The container 10 comprises a wall material 17. Preferably, at least the peripheral wall 16 comprises the wall material 17. The wall material 17 may be petroleum-based or plant-based. The wall material 17 is preferably a thermoplastic material. Suitable thermoplastic materials may be selected from the group consisting of high density polyethylene, low density polyethylene, polypropylene, biaxially oriented polypropylene polyethylene, polyethylene terphthalate, polyethylene terephthalate glycol, processable polylactic acid, polyvinyl chloride, thermoplastic starch, cellulose bioplastic, aliphatic polyesters, polylactic acid, and mixtures thereof.

The thermoplastic material may comprise recycled material, regrind material, or combinations thereof. Examples of “recycled” materials may include post-consumer recycled (PCR) materials, post-industrial recycled (PIR) materials, and mixtures thereof. Examples of “regrind” material may include thermoplastic waste material, such as sprues, runners, excess parison material, and reject parts from injection and blow molding and extrusion operations, which has been reclaimed by shredding or granulating.

The container 10 can be formed by injection molding, injection stretch blow molding, extrusion blow molding, or similar process. The container 10 is preferably a blow-molded container. The container 10 can be formed by injection stretch blow molding. The container 10 can be a thermoformed container.

The wall material 17 is preferably selected to be capable of blocking or absorbing ultraviolet (UV) light 51, preferably UV light 51 emitted by the sun 50. The proper selection of the wall material 17 may preferably lead to absorbed UV rays 52 and/or blocked or reflected UV rays 53.

The peripheral wall 16 (and/or the wall material 17 as it resides in the container 10) may be characterized by a light transmittance of less than 50%, preferably less than about 25%, more preferably less than about 10%, even more preferably less than about 5%, even more preferably less than about 1% of light in the ultraviolet part of the spectrum (e.g, at wavelength of about 1 nm to about 400 nm, preferably from about 200 nm to about 400 nm, preferably from about 280 nm to about 400 nm).

The wall material 17 may be opaque, which may be accomplished by selection of the thermoplastic material and/or the addition of proper dyes or opacifier. By being opaque, the wall material 17 is expected to be able to advantageously block and/or absorb UV light. For example, opaque wall materials that may be used include, but are not limited to: high-density polyethylene (HDPE), low-density polyethylene (LDPE), or mixtures thereof. The opaque wall material 17 may comprise post-consumer recycled (PCR) material.

The wall material 17 may be transparent or translucent. Such materials may be preferred so that the consumer can see the consistency or volume level of the treatment composition 100 contained in the container 10. Clear wall materials that may be used include, but are not limited to: polypropylene (PP), polyethylene (PE), polycarbonate (PC), polyamides (PA), polyethylene terephthalate (PETE), polyvinylchloride (PVC), and/or polystyrene (PS).

The peripheral wall 16 (and/or the wall material 17 as it resides in the container 10) may be characterized by a light transmittance of greater than 25%, preferably greater than about 30%, or greater than about 40%, or greater than about 50% in the visible part of the spectrum (e.g., at wavelength of about 410 nm to about 800 nm).

When the wall material 17 is transparent or translucent, it is preferred that the wall material 17 comprises a UV-light absorption agent. As used herein, the term “UV-light absorption agent” includes any single compound or combination of compounds that absorbs or reflects UV light, when incorporated into plastic package components, such that transmission of UV light to the container contents is reduced. For example, the UV-absorption agent preferably absorbs or reflects light in the wavelength range of from about 200 nm to about 400 nm, preferably from about 280 nm to about 400 nm. The wavelength range of the light absorbed may vary outside the above range depending on the UV-absorption agent(s) utilized. The wall material may absorb or reflect light in other spectrums as well, so long as it absorbs or reflects light in at least the given spectrum.

Suitable UV-light absorption agents (sometimes called “UV blockers” and/or “UV absorbers”) may be selected by one of ordinary skill in the art for a given wall material 17 and/or process for making the container 10. For example, examples of UV-light absorption agents that are suitable as additives for plastic packaging can be found in the Handbook of Industrial Chemical Additives (VCH Publishers) and 2002 McCutcheon's, Volume 2: Functional Materials, North American Edition (The Manufacturing Confectioner Publishing Co.).

Suitable UV-light absorption agents may include benzophenones, benzotriazoles, oxalanilides, benzylidene malonates, phenyl substituted triazines, salicyclates, benzotriazoles, hindered amines, alkoxy (e.g., methoxy) cinnamates, titanium dioxide (preferably ultra-fine titanium dioxide), and zinc oxide. Among the benzotriazole UV-light absorption agents which may be used are 2-(2-hydroxy-5-methylphenyl) benzotriazole which is available as Tinuvin P from Ciba-Geigy Corp. of Tarrytown, N.Y. Other UV-light absorption agents include, but are not limited to: phenyl benzimidazole sulfonic acid (sold as Neo Heliopan, Type Hydro by Haarmann and Reimer Corp.), 2-hydroxy-4-methoxybenzophenone-5-sulfonic acid (sold as Syntase 230 by Rhone-Poulenc and Uvinul MS-40 by BASF Corp.), sodium 2,2′-dihydroxy-4,4′-dimethoxy-5-sulfobenzophenone (sold as Uvinul DS-49 by BASF Corp.), and PEG-25 paraaminobenzoic acid (sold as Uvinul P-25 by Basf Corp.). Other examples of UV blockers suitable for use include TINUVIN 234, TINUVIN 326, and TINUVIN 1577 (sold by Ciba Speciality Chemicals, Inc.) and SANDUVOR VSU (an oxalanilide derivative) and SANDUVOR 3035 (a benzophenone) (sold by Clariant Corporation).

The UV-light absorption agent may be present in the wall material 17 at a level of from about 0.01% to about 3%, preferably from about 0.01% to about 2%, by weight of the wall material.

The wall material 17 may comprise a tinting agent, which may be selected from inorganic pigments, organic pigments, and/or organic dyes. The tinting agent may act to reduce the transmission of UV light through the wall. A tinting agent may be used in combination with a UV-absorption agent.

The container 10 may comprise a transition piece 26. The container may comprise a spout 28 at the open end 20; the spout 28 may be part of the transition piece 26. The consumer product 1 may comprise a closure 30, which can be used to seal the open end 20, for example by snapping onto or begin threadably engageable with the container 1, such as the transition piece 26. The closure 30 may be conveniently used as a dosing cup.

The container 10 comprises an internal volume 32, which may be formed by the closed end 12 and the peripheral wall 16. The container 10 may be of any form or size suitable for storing and packaging liquids for household use. For example, the container may have any size but usually the container 10 will have a maximal capacity of about 0.05 to about 15 L, or about 0.1 to about 5 L, or from about 0.2 to about 2.5 L.

The treatment composition 100 is contained or otherwise disposed in the container 1, specifically in the internal volume 32 of the container 1. Preferably, the treatment composition 100 is in the form of a liquid so that it may be dispensed out the open end 20 by pouring. When the treatment composition is in the form of a solid, such as a powder or a bead/pastille, the composition may be dispensed, for example, by pouring or by scooping.

The treatment compositions are according to the present disclosure. The above disclosure with regard to the treatment compositions, the delivery particles, adjunct ingredients, etc., applies equally here, provides many more details, and will not be repeated for the sake of brevity. In short, the treatment composition comprises a population of delivery particles. The delivery particles comprise a core and a shell surrounding the core. The core comprises a benefit agent, preferably fragrance material comprising perfume raw materials. The shell comprises a polymeric material that is the reaction product of a polyisocyanate and chitosan, preferably hydrolyzed chitosan. Preferably, the treatment composition is a fabric care composition, more preferably a fabric conditioning composition, even more preferably a liquid fabric conditioning composition.

FIG. 2 shows a consumer product 1 in which the container 10 that contains the treatment composition 100 further comprises a sleeve 60 disposed on the peripheral wall 16 of the container 10. The sleeve 60 may act as a label and may contain indicia printed thereon. The sleeve 60 is preferably a shrink sleeve, which may be heat-shrunk around the container 10.

Alternatively, the sleeve 60 may be a stretch sleeve into which a pre-form or parison is blown to stretch the stretch sleeve.

The sleeve 60 may include thermoplastic materials, such as polyvinyl chloride (PVC), polyester terephthalate. (PET), oriented polypropylene (OPP), and oriented polystyrene (OPS). The sleeve may comprise one layer or a plurality of layers, such as laminated layers. The plurality of layers may include a first layer and a second layer, where the first and second layers may be made from different materials. For example, an outer layer may be selected to be suitable to be printed upon.

When the container 10 is transparent or translucent, it may be advantageous for sleeve 60 to be opaque and/or to comprise a UV-absorbing agent, particularly in areas that overlay transparent or translucent portions of the container 10. In such cases, it may be less important for the wall material 17 of the container 10 to comprise the UV-absorbing agent. Alternatively, both the wall material 17 and the sleeve 60 may comprise UV-absorbing agents. The UV-absorbing agents in the wall material 17 and the sleeve 60, when present in both, may be different (e.g., in different classes). For example, the wall material 17 may comprise a first UV-absorbing agent and the sleeve 60 may comprise a second UV-absorbing agent that is different than the first UV-absorbing agent. Additionally or alternatively, the UV-absorbing agent may be present at different weight percentage levels in the wall material 1 compared to the sleeve 60. Preferably, the sleeve 60, being a thinner material, comprises a higher weight percentage of a UV-absorbing agent than does the wall material.

The sleeve 60 may comprise one or more apertures, which may be aligned with the through hole of a handle.

### Method of Making a Treatment Composition

The present disclosure relates to processes for making any of the treatment compositions described herein. The process of making a fabric care composition, which may be a consumer product composition, may comprise the step of combining a population of delivery particles with one or more adjunct ingredients, as described herein.

The delivery particles may be combined with the one or more adjunct ingredients when the delivery particles are in one or more forms, including a slurry form, neat particle form, and/or spray dried particle form, preferably slurry form. The delivery particles may be combined with such adjuncts by methods that include mixing and/or spraying.

The treatment compositions of the present disclosure can be formulated into any suitable form and prepared by any process chosen by the formulator. The one or more adjunct ingredients and the delivery particles may be combined in a batch process, in a circulation loop process, and/or by an in-line mixing process. Suitable equipment for use in the processes disclosed herein may include continuous stirred tank reactors, homogenizers, turbine agitators, recirculating pumps, paddle mixers, high shear mixers, static mixers, plough shear mixers, ribbon blenders, vertical axis granulators and drum mixers, both in batch and, where available, in continuous process configurations, spray dryers, and extruders.

The treatment composition may be placed into a container to form a consumer product, as described herein. The container may be a bottle, preferably a plastic bottle. The treatment composition may be placed into an aerosol or other spray container according to known methods.

Combinations

Specifically contemplated combinations of the disclosure are herein described in the following numbered and/or lettered paragraphs. These combinations are intended to be illustrative in nature and are not intended to be limiting.

1. A method of treating a fabric, the method comprising the steps of: contacting a fabric with a treatment composition, wherein the treatment composition comprises a population of delivery particles, wherein the contacting step results in one or more of the delivery particles depositing on a surface of the fabric, wherein the delivery particles comprise a core and a shell surrounding the core, wherein the core comprises a benefit agent, wherein the shell wherein the shell comprises a polymeric material that is the reaction product of a polyisocyanate and chitosan; and exposing the delivery particles that are on the surface of the fabric to ultraviolet (UV) light, preferably UV light having a wavelength of from about 200 nm to about 400 nm, more preferably from about 280 nm to about 400 nm.

2. The method according to numbered paragraph 1, wherein the benefit agent comprises perfume raw materials, preferably wherein the perfume raw materials comprise at least about 20%, preferably at least about 25%, more preferably at least about 30%, more preferably at least about 40%, even more preferably at least about 50%, by weight of the fragrance by weight of the perfume raw materials, of aldehyde-containing perfume raw materials, ketone-containing raw materials, or mixtures thereof.

3. The method according to any preceding numbered paragraph, wherein the chitosan is hydrolyzed chitosan.

4. The method according to any preceding numbered paragraph, wherein the chitosan is characterized by one or more of the following:
a) a degree of deacetylization of at least 50%, preferably at least 75%, more preferably at least 85%, or even at least 92%, and/or
b) a weight average molecular weight of 95 kDa or less.

5. The method according to any preceding numbered paragraph, wherein the shell comprises the chitosan, preferably hydrolyzed chitosan, at a level of at least about 21 wt %, by weight of the shell,
preferably from about 21 wt % to about 90 wt %, more preferably from about 21 wt % to about 85 wt %, even more preferably from about 21 wt % to about 75 wt %, or even more preferably from about 21 wt % to about 55 wt %.

6. The method according to any preceding numbered paragraph, wherein the polyisocyanate is selected from the group consisting of a polyisocyanurate of toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, phenylene diisocyanate, or mixtures thereof.

7. The method according to any preceding numbered paragraph, wherein the delivery particles are formed by a process that comprises the following steps:
forming a water phase by hydrolyzing chitosan in an aqueous acidic medium at a pH of 6.5 or less and a temperature of at least 60° C. for at least one hour;
forming an oil phase comprising dissolving together at least one benefit agent and at least one polyisocyanate, optionally with an added oil;
forming an emulsion by mixing under high shear agitation the water phase and the oil phase into an excess of the water phase, thereby forming droplets of the oil phase and benefit agent dispersed in the water phase, and optionally adjusting the pH of the emulsion to be in a range from pH 2 to pH 6;
curing the emulsion by heating to at least 40° C., for a time sufficient to form a shell at an interface of the droplets with the water phase, the shell comprising the reaction product of the polyisocyanate and hydrolyzed chitosan, and the shell surrounding the core comprising the droplets of the oil phase and benefit agent.

8. The method according to any preceding numbered paragraph, wherein the weight ratio of hydrolyzed chitosan in the water phase as compared to the polyisocyanate in the oil phase is from about 21:79 to about 90:10, preferably from about 1:2 to about 10:1, more preferably from about 1:1 to about 7:1.

9. The method according to any preceding numbered paragraph, wherein the chitosan is formed by hydrolyzing chitosan in an acidic medium at a pH of 6.5 or less, preferably at a pH of from about 3 to about 6, and at a temperature of at least 45° C. for at least one hour.

10. The method according to any preceding numbered paragraph, wherein the delivery particles are characterized by a volume-weighted median particle size from about 1 to about 100 microns,
preferably from about 10 to about 100 microns, more preferably from about 15 to about 60 microns, more preferably from about 20 to about 50 microns, even more preferably from about 30 to about 40 microns.

11. The method according to any preceding numbered paragraph, wherein the delivery particles are characterized by a zeta potential of at least 15 millivolts (mV) at a pH of 4.5, or even at least 40 mV at a pH of 4.5, or even at least 60 mV at a pH of 4.5.

12. The method according to any preceding numbered paragraph, wherein the shells of the delivery particles degrade at least 60% in 60 days when tested according to test method OECD 301B.

13. The method according to any preceding numbered paragraph, wherein the contacting step occurs during the wash cycle of an automatic washing machine.

14. The method according to any preceding numbered paragraph, wherein the contacting step occurs during the rinse cycle of an automatic washing machine.

15. The method according to any preceding numbered paragraph, wherein the source of UV light is sunlight.

16. The method according to any preceding numbered paragraph, wherein at least a portion of the exposing step occurs during a passive drying process, preferably outdoors.

17. The method according to any preceding numbered paragraph, wherein at least a portion of the exposing step occurs while the fabric is being worn or otherwise used by a person, preferably outdoors.

18. The method according to any preceding numbered paragraph, wherein method further comprises a step of drying the fabric that has the one or more delivery particles on the surface of the fabric, preferably drying the fabric in an automatic drying process.

19. The method according to any preceding numbered paragraph, wherein the treatment composition further comprises one or more adjunct ingredients, preferably wherein the one or more adjunct ingredients comprises quaternary ammonium ester material.

20. A consumer product, wherein the product comprises:
a container comprising a wall material,
   wherein the wall material is capable of blocking or absorbing ultraviolet light, preferably ultraviolet light having a wavelength of from about 200 nm to about 400 nm, more preferably from about 280 nm to about 400 nm;
a treatment composition that is contained in the container,
   wherein the treatment composition comprises a population of delivery particles,
   wherein the delivery particles comprise a core and a shell surrounding the core,
      wherein the core comprises a benefit agent,
      wherein the shell comprises a polymeric material that is the reaction product of a polyisocyanate and chitosan.

21. The consumer product according to numbered paragraph 20, wherein the benefit agent comprises perfume raw materials, preferably wherein the perfume raw materials comprise at least about 20%, preferably at least about 25%, more preferably at least about 30%, more preferably at least about 40%, even more preferably at least about 50%, by weight of the fragrance by weight of the perfume raw materials, of aldehyde-containing perfume raw materials, ketone-containing raw materials, or mixtures thereof.

22. The consumer product according to any of numbered paragraphs 20-21, wherein the chitosan is hydrolyzed chitosan.

23. The consumer product according to any of numbered paragraphs 20-22, wherein the chitosan is characterized by one or more of the following:
a) a degree of deacetylization of at least 50%, preferably at least 75%, more preferably at least 85%, or even at least 92%, and/or
b) a weight average molecular weight of 95 kDa or less.

24. The consumer product according to any of numbered paragraphs 20-23, wherein the shell comprises the chitosan, preferably hydrolyzed chitosan, at a level of at least about 21 wt %, by weight of the shell,
preferably from about 21 wt % to about 90 wt %, more preferably from about 21 wt % to about 85 wt %, even more preferably from about 21 wt % to about 75 wt %, or even more preferably from about 21 wt % to about 55 wt %.

25. The consumer product according to any of numbered paragraphs 20-24, wherein the polyisocyanate is selected from the group consisting of a polyisocyanurate of toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, phenylene diisocyanate, or mixtures thereof.

26. The consumer product according to any of numbered paragraphs 20-25, wherein the delivery particles are formed by a process that comprises the following steps:
forming a water phase by hydrolyzing chitosan in an aqueous acidic medium at a pH of 6.5 or less and a temperature of at least 60° C. for at least one hour;
forming an oil phase comprising dissolving together at least one benefit agent and at least one polyisocyanate, optionally with an added oil;
forming an emulsion by mixing under high shear agitation the water phase and the oil phase into an excess of the water phase, thereby forming droplets of the oil phase and benefit agent dispersed in the water phase, and optionally adjusting the pH of the emulsion to be in a range from pH 2 to pH 6;
curing the emulsion by heating to at least 40° C., for a time sufficient to form a shell at an interface of the droplets with the water phase, the shell comprising the reaction product of the polyisocyanate and hydrolyzed chitosan, and the shell surrounding the core comprising the droplets of the oil phase and benefit agent.

27. The consumer product according to numbered paragraph 26, wherein the weight ratio of hydrolyzed chitosan in the water phase as compared to the polyisocyanate in the oil phase is from about 21:79 to about 90:10, preferably from about 1:2 to about 10:1, more preferably from about 1:1 to about 7:1.

28. The consumer product according to any of numbered paragraphs 20-27, wherein the chitosan is formed by hydrolyzing chitosan in an acidic medium at a pH of 6.5 or less, preferably at a pH of from about 3 to about 6, and at a temperature of at least 45° C. for at least one hour.

29. The consumer product according to any of numbered paragraphs 20-28, wherein the delivery particles are characterized by a volume-weighted median particle size from about 1 to about 100 microns,
preferably from about 10 to about 100 microns, more preferably from about 15 to about 60 microns, more preferably from about 20 to about 50 microns, even more preferably from about 30 to about 40 microns.

30. The consumer product according to any of numbered paragraphs 20-29, wherein the delivery particles are characterized by a zeta potential of at least 15 millivolts (mV) at a pH of 4.5, or even at least 40 mV at a pH of 4.5, or even at least 60 mV at a pH of 4.5.

31. The consumer product according to any of numbered paragraphs 20-30, wherein the shells of the delivery particles degrade at least 40% in 14 days when tested according to test method OECD 301B.

32. The consumer product according to any of numbered paragraphs 20-31, wherein the core of the perfume encapsulates further comprise a partitioning modifier,
preferably a partitioning modifier selected from the group consisting of vegetable oil, modified vegetable oil, mono-, di-, and tri-esters of C₄-C₂₄ fatty acids, isopropyl myristate, dodecanophenone, lauryl laurate, methyl behenate, methyl laurate, methyl palmitate, methyl stearate, and mixtures thereof,
   more preferably isopropyl myristate.

33. The consumer product according to any of numbered paragraphs 20-32, wherein the wall material is opaque.

34. The consumer product according to any of numbered paragraphs 20-33,
wherein the wall material is transparent or translucent, and
wherein the wall material comprises a UV-light absorption agent,
   preferably a UV-light absorption agent selected from the group consisting of benzophenones, benzotriazoles, oxalanilides, benzylidene malonates, phenyl substituted triazines, salicyclates, benzotriazoles, hindered amines, alkoxy cinnamates, titanium dioxide, and zinc oxide.

35. The consumer product according to any of numbered paragraphs 20-34, wherein the treatment composition further comprises one or more adjunct ingredients,
preferably wherein the one or more adjunct ingredients comprises quaternary ammonium ester material,
   more preferably wherein the quaternary ammonium ester material is present at a level of from about 1% to about 35%, by weight of the treatment composition.

36. The consumer product according to any of numbered paragraphs 20-35, wherein the treatment composition is in the form of a liquid,
preferably a liquid comprising from about 50% to about 97%, preferably from about 60% to about 96%, more preferably from about 70% to about 95%, or even from about 80% to about 95%, by weight of the treatment composition, of water.

37. The consumer product according to any of numbered paragraphs 20-36, wherein the treatment composition is characterized by a pH of from about 2 to about 12, or from about 2 to about 8.5, or from about 2 to about 7, or from about 2 to about 5, or from about 2 to about 4, from about 2 to about 3.7, more preferably from about 2 to about 3.5.

38. The consumer product according to any of numbered paragraphs 20-37, wherein the treatment composition is a fabric care composition, preferably a fabric conditioning composition, more preferably a liquid fabric conditioning composition.

Test Methods

It is understood that the test methods disclosed in the Test Methods section of the present application should be used to determine the respective values of the parameters of Applicant's claimed subject matter as claimed and described herein.

### Viscosity

Viscosity of liquid finished product is measured using an AR 550 rheometer/viscometer from TA instruments (New Castle, Del., USA), using parallel steel plates of 40 mm diameter and a gap size of 500 μm. The high shear viscosity at 20 s⁻¹ and low shear viscosity at 0.05 s⁻¹ is obtained from a logarithmic shear rate sweep from 0.01 s⁻¹ to 25 s⁻¹ in 3 minutes time at 21° C.

Perfume, Perfume Raw Materials (PRMs), and/or Partitioning Modifier

A. Identity and Total Quantity

To determine the identity and to quantify the total weight of perfume, perfume ingredients, or Perfume Raw Materials (PRMs), or partitioning modifier in the capsule slurry, and/or encapsulated within the delivery agent encapsulates, Gas Chromatography with Mass Spectroscopy/Flame Ionization Detector (GC-MS/FID) 15 employed. Suitable equipment includes: Agilent Technologies G1530A GC/FID; Hewlett Packer Mass Selective Device 5973; and 5%-Phenyl-methylpolysiloxane Column J&W DB-5 (30 m length×0.25 mm internal diameter×0.25 μm film thickness). Approximately 3 g of the finished product or suspension of delivery encapsulates, is weighed and the weight recorded, then the sample is diluted with 30 mL of DI water and filtered through a 5.0 μm pore size nitrocellulose filter membrane. Material captured on the filter is solubilized in 5 mL of ISTD solution (25.0 mg/L tetradecane in anhydrous alcohol) and heated at 60° C. for 30 minutes. The cooled solution is filtered through 0.45 μm pore size PTFE syringe filter and analyzed via GC-MS/FID. Three known perfume oils are used as comparison reference standards. Data Analysis involves summing the total area counts minus the ISTD area counts and calculating an average Response Factor (RF) for the 3 standard perfumes. Then the Response Factor and total area counts for the product encapsulated perfumes are used along with the weight of the sample, to determine the total weight percent for each PRM in the encapsulated perfume. PRMs are identified from the mass spectrometry peaks.

B. Amount of Non-Encapsulated Material

In order to determine the amount of non-encapsulated perfume and (optionally) partitioning modifier material in a composition such as a slurry, the following equipment can be used for this analysis, using the analysis procedure provided after the table.

| | |
|---|---|
| Gas | Agilent GC6890 equipped with Agilent 5973N mass |
| chromatograph/MS | spectrometer or equivalent, capillary column |
| | operation, quantiation based on extracted |
| | ion capability, autosampler |
| Column | 30 m × 0.25 mm nominal diameter, 0.25 μm film |
| for GC-MS | thickness, J&W 122-5532 DB-5, or equivalent. |

To prepare a perfume standard in ISS Hexane, weigh 0.050+/−0.005 g of the desired PMC perfume oil into a 50 mL volumetric flask (or other volumetric size recalculating g of perfume oil to add). Fill to line with ISS Hexane solution from above. The ISS Hexane is a 0.1 g of Tetradecane in 4 liters of hexane.

To prepare a 5% surfactant solution, weigh 50 g+/−1 g of the sodium dodecyl sulphate in a beaker and, using purified water, transfer quantitatively to a 1 liter volumetric flask, and ensure the surfactant is fully dissolved.

To prepare the sample of the PMC composition (e.g., a slurry), confirm the composition (e.g., a slurry) is well-mixed; mix if necessary. Weigh 0.3+/−0.05 g of composition sample onto the bottom of a 10 mL vial. Avoid composition on the wall of the vial.

To operate the instrument, determine a target ion for quantification for each PRM (and optionally partitioning modifier) along with a minimum of one qualifier ion, preferably two.

Calibration curves are generated from the Perfume standard for each PRM. Utilizing the sample weight and individual PRM weight %, the integration of the extracted ion (EIC) for each PRM and the amount are plotted or recorded.

The amount of free oil is determined from the response of each PRM versus the calibration curve and summed over all the different perfume materials and optionally the partitioning modifier.

C. Determination of Encapsulated Material

The determination of the encapsulated oil and optionally the partitioning modifier is done by the subtraction of the weight of free/non-encapsulated oil found in the composition from the amount by weight of total oil found in the composition (e.g. a slurry).

### Test Method for Determining log P

The value of the log of the Octanol/Water Partition Coefficient (log P) is computed for each material (e.g., each PRM in the perfume mixture) being tested. The log P of an individual material (e.g., a PRM) is calculated using the Consensus log P Computational Model, version 14.02 (Linux) available from Advanced Chemistry Development Inc. (ACD/Labs) (Toronto, Canada) to provide the unitless log P value. The ACD/Labs' Consensus log P Computational Model is part of the ACD/Labs model suite.

### Volume-Weighted Particle Size and Size Distribution

The volume-weighted particle size distribution is determined via single-particle optical sensing (SPOS), also called optical particle counting (OPC), using the AccuSizer 780 AD instrument and the accompanying software CW788 version 1.82 (Particle Sizing Systems, Santa Barbara, Calif., U.S.A.), or equivalent. The instrument is configured with the following conditions and selections: Flow Rate=1 ml/sec; Lower Size Threshold=0.50 μm; Sensor Model Number=Sensor Model Number=LE400-05 or equivalent; Autodilution=On; Collection time=60 sec; Number channels=512; Vessel fluid volume=50 ml; Max coincidence=9200. The measurement is initiated by putting the sensor into a cold state by flushing with water until background counts are less than 100. A sample of delivery capsules in suspension is introduced, and its density of capsules adjusted with DI water as necessary via autodilution to result in capsule counts of at least 9200 per ml. During a time period of 60 seconds the suspension is analyzed. The resulting volume-weighted PSD data are plotted and recorded, and the values of the desired volume-weighted particle size (e.g., the median/50^{th} percentile, 5^{th} percentile, and/or 90^{th} percentile) are determined.

The broadness index can be calculated by determining the delivery particle size at which 90% of the cumulative particle volume is exceeded (90% size), the particle size at which 5% of the cumulative particle volume is exceeded (5% size), and the median volume-weighted particle size (50% size: 50% of the particle volume both above and below this size).

Broadness Index=((90% size)−(5% size))/50% size.

### Procedure for Determination of % Degradation

To determine % degradation, the procedure set forth in the “OECD Guideline for Testing of Chemicals” 301B CO₂ Evolution (Modified Sturm Test), adopted 17 Jul. 1992, is used. For ease of reference, this test method is referred to herein as test method OECD 301B.

### Procedure for Determination of Free Oil

This method measures the amount of oil in the water phase and uses as an internal standard solution 1 mg/ml dibutyl phthalate (DBP)/hexane.

Weigh a little more than 250 mgs of DBP into a small beaker and transfer to a 250 ml volumetric rinsing the beaker thoroughly. Fill with hexane to 250 ml.

Sample Prep: Weigh approximately 1.5-2 grams (40 drops) of the capsule slurry into a 20 ml scintillation vial and add 10 ml's of the ISTD solution, cap tightly. Shaking vigorously several times over 30 minutes, pipette solution into an autosampler vial and analyze by GC.

Additional details. Instrumentation: HP5890 GC connected to HP Chem Station Software; Column: 5m×0.32 mm id with 1 μm DB-1 liquid phase; Temperature 50 deg for 1 minute then heat to 320 deg @ 15 deg/min; Injector: 275° C.; Detector: 325° C.; 2 ul injection.

Calculation: Add total peak area minus the area for the DBP for both the sample and calibration.

Calculate mg of free core oil:

$$\frac{Total area from sample}{Total area from calibration} \times mg of oil in calibration solution = mg of free oil$$

Calculate % free core oil:

$$\frac{mg of free core oil}{Sample wt . ( mg )} \times 100 = \% free core oil in wet slurry$$

### Procedure for Determination of Benefit Agent Leakage

Obtain two, 1-gram samples of benefit agent particle composition. Add 1 gram (Sample 1) of particle composition to 99 grams of product matrix in which the particle will be employed. Age the particle containing product matrix (Sample 1) for 2 weeks at 35° C. in a sealed glass jar. The other 1 gram sample (Sample 2) is similarly aged.

After 2 weeks, use filtration to recover the particle composition's particles from the product matrix (Sample 1) and from the particle composition (Sample 2). Treat each particle sample with a solvent that will extract all the benefit agent from each samples' particles. Inject the benefit agent containing solvent from each sample into a Gas Chromatograph and integrate the peak areas to determine the total quantity of benefit agent extracted from each sample.

Determine the percentage of benefit agent leakage by calculating the difference in the values obtained for the total quantity of benefit agent extracted from Sample 2 minus Sample 1, expressed as a percentage of the total quantity of benefit agent extracted from Sample 2, as represented in the equation below:

$$Precentage of Benefit Agent Leakage = ( \frac{Sample 2 - Sample 1}{Sample 2} ) \times 100$$

### EXAMPLES

The examples provided below are intended to be illustrative in nature and are not intended to be limiting.

### Synthesis Examples

In the following examples, the abbreviations correspond to the materials listed in Table 1.

TABLE 1

| Trade Name | Company/City | Material |
|---|---|---|
| Selvol 540 | Sekisui Specialty Chemicals, | Polyvinyl alcohol |
| | Dallas, TX | |
| ChitoClear | Primex EHF, Siglutjordur, Iceland | Chitosan |
| Takenate | Mitsui Chemicals America, Inc., | Aliphatic polyisocya- |
| D-110N | Rye Brook, NY | nate prepolymer |
| Mondur MR | Covestro LLC, Pittsburgh, PA | Polymeric diphenyl |
| | | methane diisocyanate |
| SAS-305 | JX Nippon Chemical Texas Inc., | Isopropyl diphenyleth- |
| | Pasadena, TX | ane |

### Synthesis Example 1

A water phase is prepared by dispersing 12.40 g ChitoClear into 350.00 g water while mixing in a jacketed reactor. The pH of the water phase is then adjusted to 4.7 using concentrated HCl under agitation. The water phase temperature is then increased to 85° C. over 60 minutes and then held at 85° C. for a period of time to hydrolyze the ChitoClear. The water phase temperature is then reduced to 25° C. after the hydrolyzing step over a period of 90 minutes. An oil phase is prepared by mixing 87.50 g perfume oil and 22.50 g isopropyl myristate together along with 15.00 g Takenate D-110N at room temperature. The oil phase is added to the water phase under high shear milling to obtain an emulsion. The emulsion is heated to 40° C. over 30 minutes and held for 60 minutes. The emulsion is then heated to 85° C. and maintained at this temperature for 6 hours while mixing.

### Synthesis Example 2

A water phase is prepared by dispersing 26.45 g ChitoClear into 450.00 g water while mixing in a jacketed reactor. The pH of the water phase is then adjusted to 6.0 using concentrated HCl under agitation. The water phase temperature is then increased to 85° C. over 60 minutes and then held at 85° C. for a period of time to hydrolyze the ChitoClear. The water phase temperature is then reduced to 25° C. after the hydrolyzing step over a period of 90 minutes. An oil phase is prepared by mixing 159.38 g perfume oil and 23.91 g isopropyl myristate together along with 4.00 g Takenate D-110N at room temperature. The oil phase is added to the water phase under high shear milling to obtain an emulsion. The emulsion is heated to 40° C. over 30 minutes and held for 60 minutes. The emulsion is then heated to 85° C. and maintained at this temperature for 6 hours while mixing.

### Synthesis Example 3

A water phase is prepared by dispersing 5.70 g ChitoClear into 350.00 g water while mixing in a jacketed reactor. The pH of the water phase is then adjusted to 4.7 using concentrated HCl under agitation. The water phase temperature is then increased to 85° C. over 60 minutes and then held at 85° C. for a period of time to hydrolyze the ChitoClear. The water phase temperature is then reduced to 25° C. after the hydrolyzing step over a period of 90 minutes. An oil phase is prepared by mixing 120.00 g perfume oil and 30.00 g isopropyl myristate together along with 3.78 g Mondur MR at room temperature. The oil phase is added to the water phase under high shear milling to obtain an emulsion. The emulsion is heated to 40° C. over 30 minutes and held for 60 minutes. The emulsion is then heated to 85° C. and maintained at this temperature for 6 hours while mixing.

### Synthesis Example 4

A water phase is prepared by dispersing 5.70 g ChitoClear into 350.00 g water while mixing in a jacketed reactor. The pH of the water phase is then adjusted to 4.0 using concentrated HCl under agitation. The water phase temperature is then increased to 85° C. over 60 minutes and then held at 85° C. for a period of time to hydrolyze the ChitoClear. The water phase temperature is then reduced to 25° C. after the hydrolyzing step over a period of 90 minutes. An oil phase is prepared by mixing 150.00 g SAS-305 with 3.78 g Mondur MR at room temperature. The oil phase is added to the water phase under high shear milling to obtain an emulsion. The emulsion is heated to 40° C. over 30 minutes and held for 60 minutes. The emulsion is then heated to 85° C. and maintained at this temperature for 6 hours while mixing.

### Performance Example. Olfactory Performance Upon Exposure to UV Light

In order to test the performance of the delivery particles of the present disclosure under UV light, fabrics are prepared by providing delivery particles in a “forced deposition” procedure in which a diluted particle slurry is applied directly to a target fabric. In this procedure, fabric swatches (each approximately 1.5-2 g) are provided.

Two perfume delivery particle slurries are provided. A first slurry includes comparative core/shell particles, where the shell is formed from a polyacrylate polymer. A second slurry includes core/shell delivery particles according to the present disclosure, where the shells are polyisocyanate/chitosan shells. The same fragrance material is provided in the cores of each particle population, at approximately the same activity level.

For each slurry, a first dilution is formed by diluted 0.5 g of the slurry in 90 g of demineralized water. From each first dilution, a second dilution is formed by diluting approximately 0.08 g of the first dilution in about 10 g of demineralized water.

In order to provide delivery particles to the fabrics, approximately 1.1 g of a second dilution is applied to each fabric swatch. Half of the fabric swatches are spiked with second dilutions made from the first (comparative) slurry; these are called Group A swatches. The other half are spiked with seconds dilutions made from the second slurry; these are called Group B swatches.

| | |
|---|---|
| Group A swatches | Treated with comparative delivery particles having |
| (comp.) | polyacrylate shells |
| Group B swatches | Treated with delivery particles having |
| | polyisocyanate/chitosan shells |

The fabric swatches are dried on a drying rack overnight. After the fabric swatches have been dried, each of the Group A and B swatches are divided into two sub-groups. Half of the sub-groups are kept in the dark; half are exposed to ultraviolet (UV) light.

The UV light is supplied by a UV lamp (ex Analytik Jena US, California, USA; model UVP UVGL-58; 6 Watt; 0.16 Ampere), set to provide UV at a wavelength of 254 nm (shortwave) at a distance of 10 cm away from the fabric. Based on the set-up, there is no significant heat added, or rise in temperature created, due to the lamp.

The treated fabrics are assessed via a small panel sniff test. The panelists smell the test fabrics for each condition (dark/UV light) and assess which group (A or B, distinguished by the delivery particles applied) provides a more intense perfume smell at the dry fabric odor (DFO) touchpoint. Assessments are determined at an initial time (time 0), then one and three hours later. Results are provided in Table 1 below. In the table, Group A is marked with an asterisk (*) to indicate that those include the comparative delivery particles.

TABLE 1

| | Relatively Greater Perfume Intensity (DFO) by Condition | |
|---|---|---|
| Time Elapsed | Dark | UV Light |
| Time 0 | Group A* | Group A* |
| One Hour | Group A* | Group B |
| Three Hours | Equal | Equal |

As shown in Table 1, the fabric swatches in Group A, which are treated with the comparative polyacrylate delivery particles, provide relatively greater perfume intensity at the initial starting time (Time 0). After three hours, the perfume intensity upon storage for three hours is relatively the same for both swatches, regardless of light condition, indicating that after an extended time, there is little difference between the particles with regard to DFO intensity.

However, an interesting result emerges at the One Hour time point. Group A fabric swatches, which provided the greater perfume intensity at the starting time, continue to provide a greater intensity after one hour of being stored in the dark. However, for the fabric swatches stored under the UV light, Group B, which includes the polyisocyanate/chitosan delivery particles, provides a relatively greater perfume intensity at the One Hour time point.

To note, as a result of the size and position of the UV lamp used in the test, the light provides a greater light intensity than is provided by the sun for a given surface area. Thus, it is believed that the effect shown under the UV lamp after one hour of exposure is comparable to the UV exposure experienced under longer period of exposure time in natural sunlight. In view of this, it is believed that the delivery particles of the present disclosure will provide a heightened olfactory experience when fabrics treated with the particles are exposed to sunlight, for example through when taking the fabrics off an outdoor clothesline and folding them, or wearing treated garments outdoors in the sunshine.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating a fabric, the method comprising the steps of:
contacting a fabric with a treatment composition,
wherein the treatment composition comprises a population of delivery particles,
wherein the contacting step results in one or more of the delivery particles depositing on a surface of the fabric,
wherein the delivery particles comprise a core and a shell surrounding the core,
wherein the core comprises a benefit agent,
wherein the shell wherein the shell comprises a polymeric material
that is the reaction product of a polyisocyanate and chitosan; and
exposing the delivery particles that are on the surface of the fabric to ultraviolet (UV) light having a wavelength of from about 200 nm to about 400 nm.

2. The method according to claim 1, wherein the benefit agent comprises perfume raw materials.

3. The method according to claim 1, wherein the chitosan is characterized by one or more of the following:
a) a degree of deacetylization of at least 50%, preferably at least 75%, more preferably at least 85%, or even at least 92%, and/or
b) a weight average molecular weight of 95 kDa or less.

4. The method according to claim 1, wherein the shell comprises the chitosan at a level of at least about 21 wt %, by weight of the shell,
preferably from about 21 wt % to about 90 wt %, more preferably from about 21 wt % to about 85 wt %, even more preferably from about 21 wt % to about 75 wt %, or even more preferably from about 21 wt % to about 55 wt %.

5. The method according to claim 1, wherein the polyisocyanate is selected from the group consisting of a polyisocyanurate of toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, phenylene diisocyanate, or mixtures thereof.

6. The method according to claim 1, wherein the delivery particles are formed by a process that comprises the following steps:
forming a water phase by hydrolyzing chitosan in an aqueous acidic medium at a pH of 6.5 or less and a temperature of at least 60° C. for at least one hour;
forming an oil phase comprising dissolving together at least one benefit agent and at least one polyisocyanate, optionally with an added oil;
forming an emulsion by mixing under high shear agitation the water phase and the oil phase into an excess of the water phase, thereby forming droplets of the oil phase and benefit agent dispersed in the water phase, and optionally adjusting the pH of the emulsion to be in a range from pH 2 to pH 6;
curing the emulsion by heating to at least 40° C., for a time sufficient to form a shell at an interface of the droplets with the water phase, the shell comprising the reaction product of the polyisocyanate and hydrolyzed chitosan, and the shell surrounding the core comprising the droplets of the oil phase and benefit agent.

7. The method according to claim 6, wherein the weight ratio of hydrolyzed chitosan in the water phase as compared to the polyisocyanate in the oil phase is from about 21:79 to about 90:10.

8. The method according to claim 1, wherein the chitosan is formed by hydrolyzing chitosan in an acidic medium at a pH of 6.5 or less, and at a temperature of at least 45° C. for at least one hour.

9. The method according to claim 1, wherein the delivery particles are characterized by a volume-weighted median particle size from about 1 to about 100 microns.

10. The method according to claim 1, wherein the delivery particles are characterized by a zeta potential of at least 15 millivolts (mV) at a pH of 4.5, or even at least 40 mV at a pH of 4.5, or even at least 60 mV at a pH of 4.5.

11. The method according to claim 1, wherein the shells of the delivery particles degrade at least 60% in 60 days when tested according to test method OECD 301B.

12. The method according to claim 1, wherein the contacting step occurs during the rinse cycle of an automatic washing machine.

13. The method according to claim 1, wherein the source of UV light is sunlight.

14. The method according to claim 1, wherein at least a portion of the exposing step occurs during a passive drying process.

15. The method according to claim 1, wherein at least a portion of the exposing step occurs while the fabric is being worn or otherwise used by a person.

16. The method according to claim 1, wherein method further comprises a step of drying the fabric that has the one or more delivery particles on the surface of the fabric.

17. The method according to claim 1, wherein the treatment composition further comprises one or more adjunct ingredients.

18. A consumer product, wherein the product comprises:
a container comprising a wall material,
wherein the wall material is capable of blocking or absorbing ultraviolet light, preferably ultraviolet light having a wavelength of from about 200 nm to about 400 nm, more preferably from about 280 nm to about 400 nm;
a treatment composition that is contained in the container,
wherein the treatment composition comprises a population of delivery particles, wherein the delivery particles comprise a core and a shell surrounding the core,
wherein the core comprises a benefit agent,
wherein the shell comprises a polymeric material that is the reaction product of a polyisocyanate and chitosan.

19. The consumer product according to claim 18, wherein the wall material is opaque.

20. The consumer product according to claim 18,
wherein the wall material is transparent or translucent, and
wherein the wall material comprises a UV-light absorption agent.
